(19) United States
(12) Patent Application Publication
(10) Pub. No.: US 2025/0333273 A1
(43) Pub. Date: Oct. 30, 2025

(54) Electric Winch with Radial Electric Clutch

(71) Applicant: Ningbo Chima Winch Co., Ltd, Zhejiang (CN)

(72) Inventor: Mingkui ZHENG, Zhejiang (CN)

(73) Assignee: Ningbo Chima Winch Co., Ltd, Zhejiang (CN)

(21) Appl. No.: 18/934,296

(22) Filed: Nov. 1, 2024

(30) Foreign Application Priority Data
Apr. 29, 2024 (CN) 202410529548.9

(51) Int. Cl. B66D 1/22; B66D 1/12

(52) U.S. Cl. CPC B66D 1/22; B66D 1/12

(57) ABSTRACT

An electric winch with a radial electric clutch, which comprises a bracket, a winch drum, a planetary gear reducer and an electric motor, wherein a labor-saving lever structure is provided on the circumference of the planetary gear reducer; the side of a power arm of the labor-saving lever structure is connected with an electric drive unit, and the side of a resisting arm of the labor-saving lever structure is hinged with a straight pin which moves radially, and the straight pin fits with a radial limit hole of an inner gear ring of the planetary gear reducer; the electric drive unit is provided with a retractable output end having a structure which is in an abutment with the side of the power arm, and the straight pin is connected with an elastic element for driving the straight pin to be inserted into the radial limit hole.

### CROSS-REFERENCE TO RELATED APPLICATIONS

This application claims the priority of China patent application No. CN202410529548.9 filed on Apr. 29, 2024, entitled “Electric Winch with Radial Electric Clutch”, the entire contents and amendments of which are all incorporated herein by reference.

### TECHNICAL FIELD

The present disclosure relates to the technical field of winches, in particular to an electric winch with a radial electric clutch.

### BACKGROUND

At present, there is an electric winch, which includes a bracket, a winch drum installed in the bracket, a planetary gear reducer connected to the bracket and an electric motor, wherein the electric motor is in transmission connection with the planetary gear reducer, and the planetary gear reducer is connected with the winch drum, so that the electric motor drives the winch drum to rotate forward or backward.

The electric winch is generally used in vehicles, such as off-road vehicles, ATVs, ships, etc. Of course, it can be used in other places where it is needed, that is, the application scene is relatively wide, and it is suitable for many occasions that need traction function.

The electric winch is provided with a clutch structure, so as to realize the power connection or disconnection between the electric motor and the winch drum. At present, there is an electric winch with electric clutch, which is provided with a telescopic shaft on the circumference of the planetary gear reducer. The telescopic shaft is directly driven by an electromagnetic structure, and corresponds to a gear ring in the planetary gear reducer. The gear ring is fixed/un-fixed by inserting/pulling the telescopic shaft into/from a radial hole on the gear ring, thus achieving the purpose of electric clutch. For example, an electromagnetic clutch type electric winch disclosed in China patent with the authorization number of CN205740118U has a fast response, but it is not easy to be pulled out. If a large pulling force is to be provided, the electromagnetic structure needs to be set very large.

The other is the eccentric principle, such as an electric clutch winch disclosed in China patent application No. CN106966314A. The working principle is that the remote controller is used to drive the deceleration motor to work, and the deceleration motor drives the eccentric wheel to rotate, so that the linkage frame moves up and down, driving the straight pin to engage or disengage from the limit engagement with the small inner gear ring, thus enabling the clutch control device to realize the automatic clutch function. The initial position of the eccentric wheel in the clutch control device is at the top dead center C, and the initial state is closed at this time. When the signal receiver receives the instruction of the remote controller to leave, the turntable rotates, and at the same time, the eccentric wheel rotates, and the linkage frame rises. When the trigger lever touches the second trigger button of the limit switch, the deceleration motor stops rotating, and the eccentric wheel reaches the top dead center C, and the straight pin leaves the small inner gear ring, and the clutch control device is in the off state. The above solution is complicated in structure, and the limit fit or separation fit between the straight pin and the small inner gear ring is completely realized by the rotation fit of the eccentric wheel and the linkage frame, so there are some problems. Specifically, when the straight pins are in limit fit with the small inner gear ring, if the straight pins are not aligned with the limit holes on the small inner gear ring, the reduction motor will be blocked. When the straight pins and the small inner gear ring are required to be released from the limit fit, the eccentric wheel and the linkage frame are used to exert force. Therefore, the direction of force application is not coaxial in the process of pulling out the straight pin, that is to say, there is a transverse force component in the direction of force application, and wear is easy to occur between the side wall of the straight pin and the hole edge of the limit hole on the small inner gear ring.

Therefore, the applicant will propose an electric winch with a radial electric clutch, which is beneficial to solve these problems and has high reliability.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides an electric winch with a radial electric clutch, which includes a bracket, a winch drum installed in the bracket, a planetary gear reducer connected to the bracket and an electric motor, wherein the electric motor is in transmission connection with the planetary gear reducer, and the planetary gear reducer is connected with the winch drum, wherein a labor-saving lever structure is provided on the circumference of the planetary gear reducer, and the labor-saving lever structure includes a power arm and a resisting arm; a side of the power arm is connected with an electric drive unit, and a side of the resisting arm is hinged with a straight pin which moves radially; the straight pin is connected with a radial limit hole of an inner gear ring of the planetary gear reducer; and the electric drive unit is provided with a telescopic output end, and an abutting structure is provided between the side of the power arm and the output end; and the straight pin is connected with an elastic element which is used for driving the straight pin to be inserted into the radial limit hole; and
with the abutting structure, when separation is needed, the output end extend out and abuts against the side of the power arm to push the power arm, thereby driving the resisting arm to tilt, and the tilting of the resisting arm drives the straight pin to move radially to pull out the radial limit hole, thereby completing separation, while the elastic element is compressed or stretched by the straight pin to accumulate elastic potential energy; when recombination is needed, the output end retracts to release the limit to the power arm; under the action of the elastic potential energy, the straight pin moves reversely to push back the resisting arm, thus driving the power arm to reset; if the straight pin is aligned with the radial limit hole at this time, the straight pin is inserted into the radial limit hole to realize recombination; if the straight pin is not aligned with the radial limit hole at this time, the output end continues to retract, further away from the power arm to release the limit, while a front end of the straight pin elastically abuts against an outer peripheral surface of the inner gear ring under the action of the elastic potential energy; then when the inner gear ring rotates until the straight pin is relatively aligned with the radial limit hole, the straight pin will be inserted into the radial limit hole conveniently to realize recombination under the action of the elastic potential energy, and meanwhile, the release of the limit allows the power arm to realize the reset without obstacles.

The present disclosure further provides an electric winch with a radial electric clutch, which includes a bracket, wherein a rotatable winch drum, a planetary gear reducer drivingly connected with the winch drum and an electric motor for driving the planetary gear reducer are installed on the bracket in sequence; and
wherein, an electric clutch device operable to be disengaged is provided on the circumference of the planetary gear reducer, and the electric clutch device includes a labor-saving lever structure and an electric drive unit; and
wherein, the labor-saving lever structure includes a resisting arm and a power arm connected with the electric drive unit, and the resisting arm is hinged with straight pins; and
wherein the planetary gear reducer includes at least one inner gear ring, which is provided with a plurality of radial limit holes fitted with the straight pins, and the straight pins are driven by the electric drive unit to be separated from the radial limit holes during clutching.

The present disclosure further provides an electric winch with a radial electric clutch, which includes a bracket, an electric motor installed on the bracket, a planetary gear reducer driven by the electric motor and a winch drum drivingly connected with the planetary gear reducer, wherein the planetary gear reducer includes at least one inner gear ring, an electric drive unit and a labor-saving lever structure driven by the electric drive unit, and the inner gear ring is provided with a plurality of radial limit holes fitted with the labor-saving lever structure; and
wherein, the labor-saving lever structure is driven by the electric drive unit and enters or exits one of the plurality of radial limit holes in the inner gear ring.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a perspective view of an electric winch with a radial electric clutch.

FIG. 2 is a schematic perspective view of the shell of a planetary gear reducer.

FIG. 3 is a front view of the shell of a planetary gear reducer.

FIG. 4 is a cross-sectional view taken along line A-A of FIG. 3.

FIG. 5 is a three-dimensional schematic view of the fitting between the straight pin and the second-stage inner gear ring.

FIG. 6 is a three-dimensional schematic diagram displayed from the inside perspective of the shell of a planetary gear reducer with the labor-saving lever structure and the second-stage inner gear ring removed.

FIG. 7 is a a three-dimensional schematic diagram displayed from the top perspective of the shell of a planetary gear reducer with the labor-saving lever structure and the second-stage inner gear ring removed.

FIG. 8 is a front view of the shell of a planetary gear reducer with the labor-saving lever structure and the second-stage inner gear ring removed.

FIG. 9 is a sectional view taken along line B of FIG. 8.

FIG. 10 is a schematic perspective view of a labor-saving lever structure;

FIG. 11 is a sectional view of an electric winch with a radial electric clutch shown in FIG. 1;

FIG. 12 is a partial schematic view of the planetary gear reducer of the radial electric clutch electric winch shown in FIG. 1;

FIG. 13 is a partial schematic view of the planetary gear reducer of the electric winch with a radial electric clutch shown in FIG. 12 with the shell removed.

### REFERENCE SIGNS

Bracket (1); Winch drum (2); Planetary gear reducer (3); Electric motor (4); Labor-saving lever structure (5); Electric drive unit (6); Power arm (7); Resisting arm (8); Support (9); Rotating shaft (10); straight pin (11); Inner gear ring (12); Radial limit hole (13); Output end (14); Elastic element (16); Output shaft (17); Support plane (18); Guide cambered surface (19); Vertical surface (20); Guide hole (21); First limit ring (22); Top surface (23); Second limit ring (24); First-stage inner gear ring (25); Second-stage inner gear ring (26); Decorative end cover (27); Shell (28); Hinge shaft (29); Casing (30).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

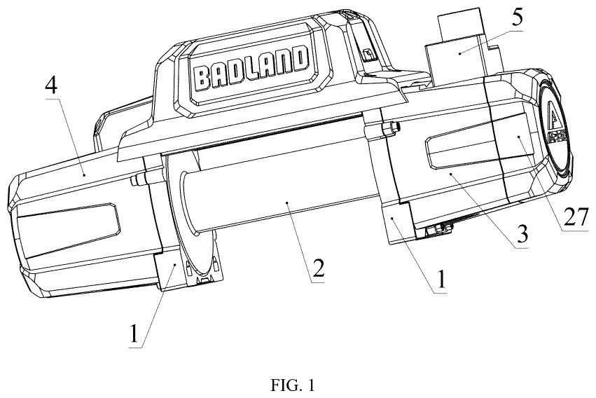

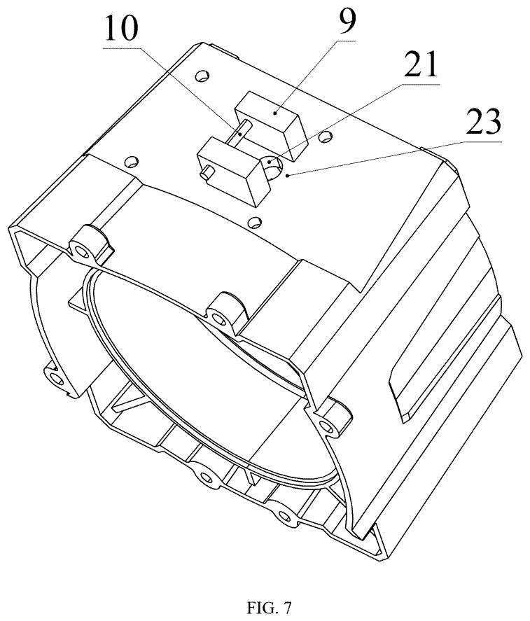

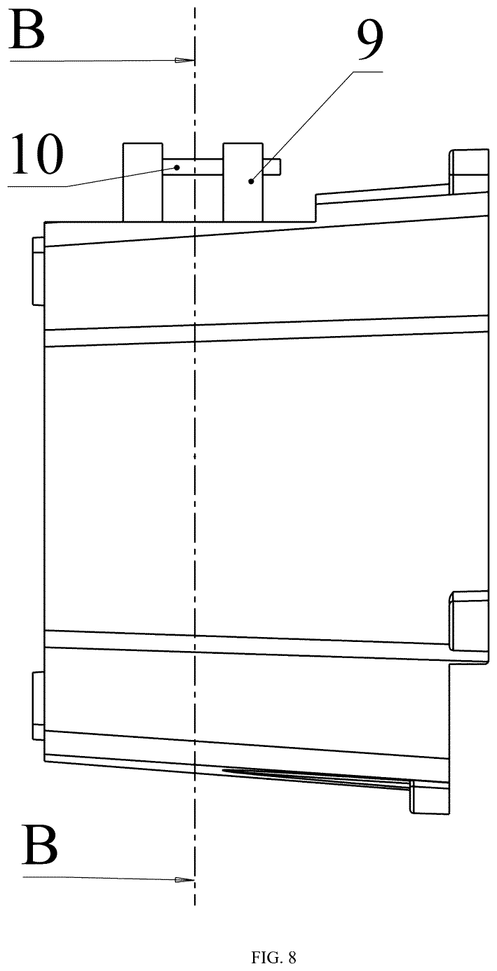

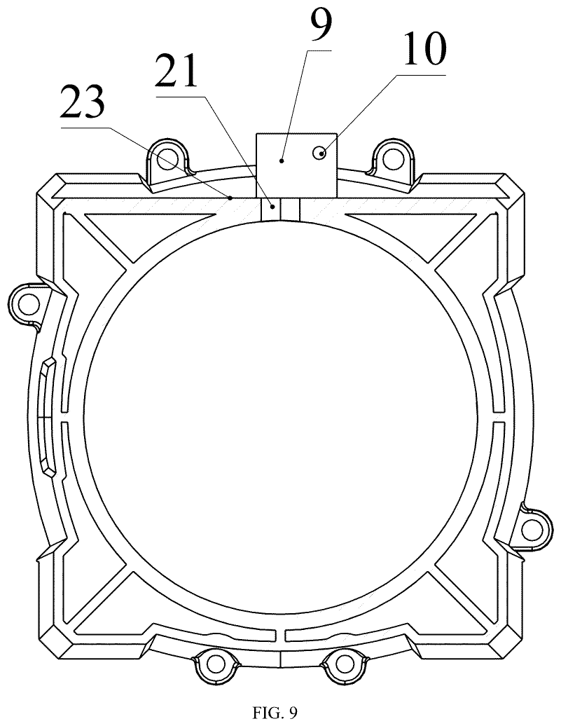

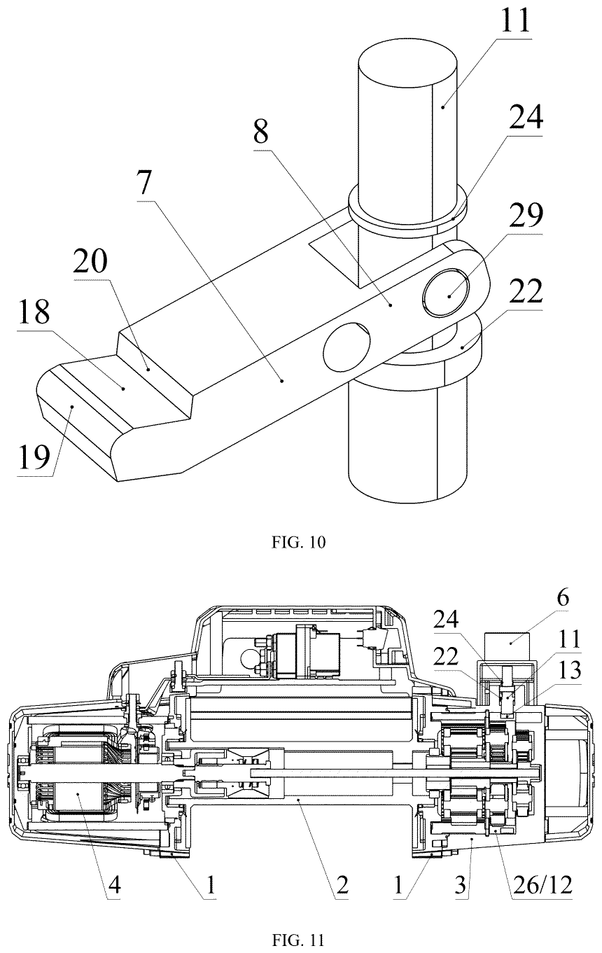

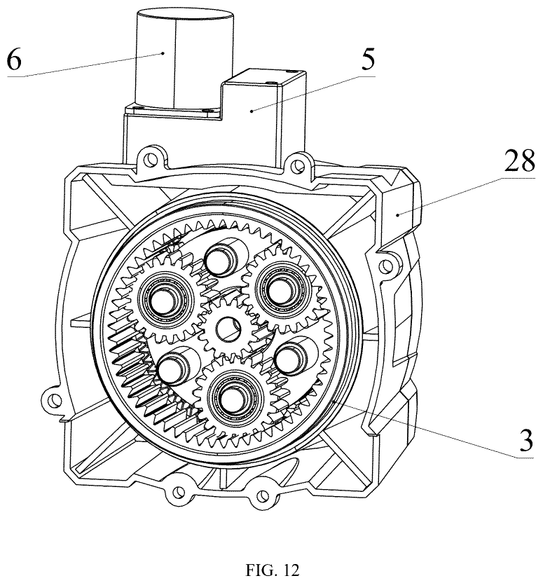

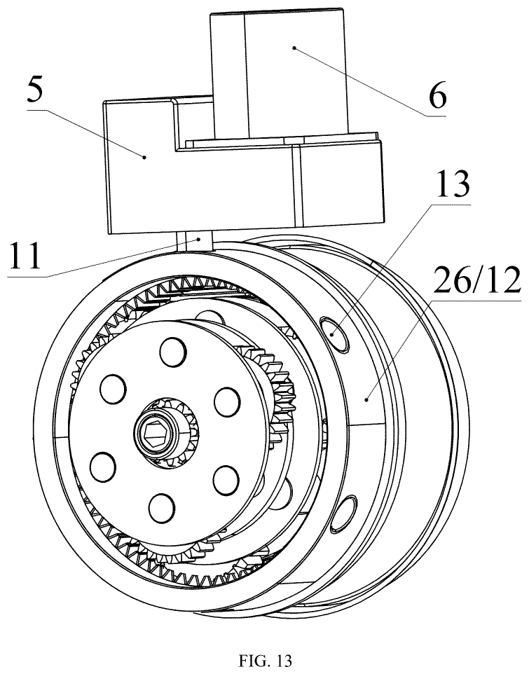

As shown in FIGS. 1 to 10, the present disclosure provides an electric winch with a radial electric clutch, which includes a bracket 1, a winch drum 2 installed in the bracket 1, a planetary gear reducer 3 connected to the bracket 1 and an electric motor 4 in transmission connection with the planetary gear reducer 3. The planetary gear reducer 3 is connected to the winch drum 2, and a labor-saving lever structure 5 is provided on the circumference of the planetary gear reducer 3. A side of the power arm 7 of the labor-saving lever structure 5 is connected with the electric drive unit 6, and a side of the resisting arm 8 of the labor-saving lever structure 5 is hinged with a straight pin 11 which moves radially, and the straight pin 11 is connected with a radial limit hole 13 of an inner gear ring 12 of the planetary gear reducer 3. The electric drive unit 6 is provided with a telescopic output end 14, and there is an abutting structure between the side of the power arm 7 and the output end 14. The straight pin 11 is connected with an elastic element 16 which is used for driving the straight pin 11 to be inserted into the radial limit hole 13.

With the abutting structure, when separation is needed, the output end 14 extend out and abuts against the side of the power arm 7 to push the power arm 8, thereby driving the resisting arm 8 to tilt, and the tilting of the resisting arm 8 drives the straight pin 11 to move radially to pull out the radial limit hole 13, thereby completing separation, while the elastic element 16 is compressed or stretched by the straight pin 11 to accumulate elastic potential energy; when recombination is needed, the output end 14 retracts to release the limit to the power arm 7; under the action of the elastic potential energy, the straight pin 11 moves reversely to push back the resisting arm 8, thus driving the power arm 7 to reset; if the straight pin 11 is aligned with the radial limit hole 13 at this time, the straight pin 11 is inserted into the radial limit hole 13 to realize recombination; if the straight pin 11 is not aligned with the radial limit hole 13 at this time, the output end 14 continues to retract, further away from the power arm 7 to release the limit, while a front end of the straight pin 11 elastically abuts against an outer peripheral surface of the inner gear ring 12 under the action of the elastic potential energy; then when the inner gear ring 12 rotates until the straight pin 11 is relatively aligned with the radial limit hole 13, the straight pin 11 will be inserted into the radial limit hole 13 conveniently to realize recombination under the action of the elastic potential energy, and meanwhile, the release of the limit allows the power arm 7 to realize the reset without obstacles.

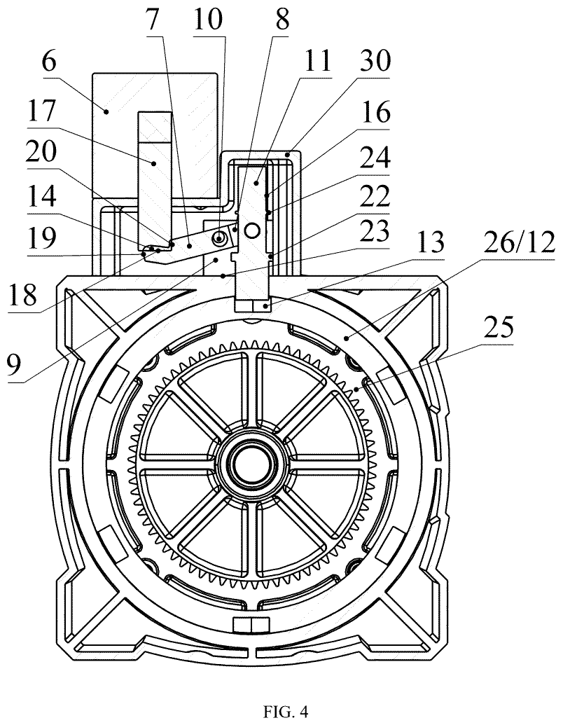

As shown in FIG. 4, the electric drive unit 6 adopts an electromagnetic push rod, and the telescopic end of the electromagnetic push rod serves as the output end 14. The telescopic output shaft 17 of the electromagnetic push rod is driven by electromagnetic force, which is fast in expansion and contraction. When applied in this disclosure, it can not only take advantage of the rapid response of the electromagnetic push rod, but also solve the problem that it is not easy to pull out due to insufficient strength, and the reliability is greatly improved. In addition, due to the arrangement of the labor-saving lever structure 5, the electromagnetic push rod can adopt a smaller volume.

In some embodiments, as shown in FIG. 4, the labor-saving lever structure 5 includes a support 9, and the support 9 is provided with a rotating shaft 10. The power arm 7 and the resisting arm 8 are located at the two sides of the rotating shaft 10, and the straight pin 11 is hinged to one end of the resisting arm 8 far from the rotating shaft 10 through a hinge shaft 29. In this way, the labor-saving lever structure 5 can amplify the up-and-down moving stroke of the power arm 7, so that the resisting arm 8 has enough up-and-down moving stroke, so that the up-and-down moving stroke of the power arm 7 can be shorter, which is beneficial to reducing the telescopic amplitude of the output end 14.

Of course, other labor-saving lever structures 5 can be adopted, and any labor-saving lever structure 5 suitable for this disclosure can be applied to this disclosure.

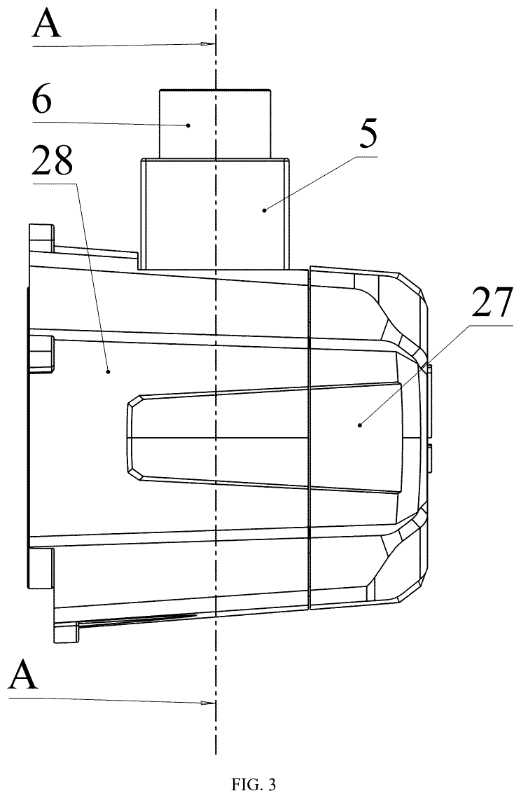

As shown in FIGS. 3 and 4, the top of the planetary gear reducer 3 is provided with a labor-saving lever structure 5, and the straight pin 11 is vertically arranged. The output end 14 is provided by an output shaft 17, and the output shaft 17 is also vertically arranged. In this way, the direction of force application is more optimized.

In some embodiments, as shown in FIGS. 4, 5 and 10, the upper side of an end of the power arm 7 far away from the support 9 of the labor-saving lever structure 5 is provided with a support plane 18, and the output end 14 is located on the upper side of the support plane 18. The output end 14 is vertically fitted with the support plane 18, and the end of the one end is provided with a guide cambered surface 19, which moves upward together with the power arm 7 and is located below a lower side of the output end 14 when being separated; the output end 14 moves downward to first abut against the guide cambered surface 19 when being recombined, and resumes the fitting with the support plane 18 under the guidance of the guide cambered surface 19, thus completely recombining.

On the one hand, due to the fast extension speed of the electromagnetic push rod,

the arrangement of the guide cambered surface 19 is not only beneficial to the mutual cooperation between the output end 14 and the power arm 7, but also can improve the reliability and reduce the wear. On the other hand, the arrangement of the support plane 18 is beneficial to the good fitting between the output end 14 and the power arm 7, and the output end 14 and the power arm 7 can form a stable and reliable support limit, thus keeping the position of the straight pin 11 stable when it is pulled out. Although the elastic element 16 is in the state of accumulating elastic potential energy at this time, the above improvement enables the straight pin 11 to remain stable in the pulled-out state.

In some embodiments, as shown in FIGS. 4, 5 and 10, the side of the support plane 18 near the support 9 is provided with a vertical surface 20, which forms an L-shaped structure with the support plane 18. In this way, the electromagnetic push rod has a certain impact on the power arm 7 because of its fast extension speed, and the L-shaped structure makes the output end 14 and the L-shaped structure quickly form a stable fitting structure after the electromagnetic push rod is extended in place, thus reducing the impact on the labor-saving lever structure 5.

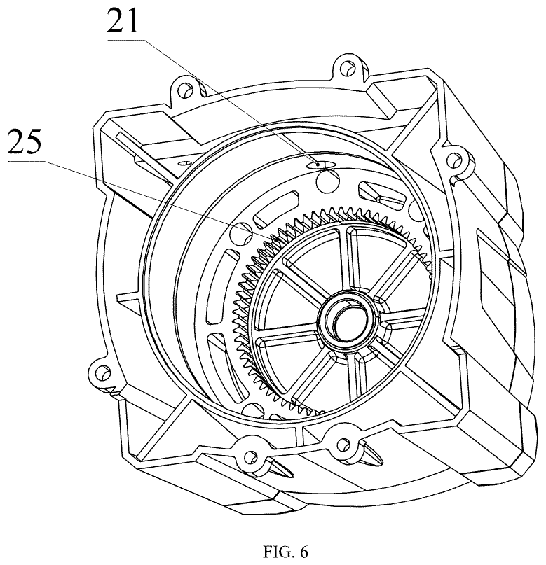

In some embodiments, as shown in FIGS. 6, 7 and 9, the planetary gear reducer 3 further includes a shell, and the shell 28 is provided with a guide hole 21 for guiding engagement with the straight pin 11. In this way, on the one hand, the guide hole 21 can form a guide support for the straight pin 11, which makes the insertion and removal of the straight pin 11 and the radial limit hole 13 more stable and reliable, and improves the reliability; on the other hand, it has stronger limit strength for the inner gear ring 12, and improves the safety.

In some embodiments, as shown in FIGS. 4, 5 and 10, the straight pin 11 is provided with a first limit ring 22, which fits with the top surface 23 of the shell 28 to limit the straight pin 11. This limit is used to limit the straight pin 11 during recombination, that is, the first limit ring is used to limit the movement stroke of the straight pin in the radial direction of the shell. This structure is simple and convenient for production and manufacture.

In some embodiments, as shown in FIGS. 4, 5 and 10, the straight pin 11 is provided with a second limit ring 24, and the upper side of the straight pin 11 is provided with an elastic element 16. The lower end of which abuts against the second limit ring 24, and the upper end of the elastic element 16 is fixed. The elastic element 16 pushes the straight pin 11 downward through the second limit ring 24. In this way, the structure is simple, and the urging direction of the elastic element 16 is along the axial direction of the straight pin 11, so the urging direction is optimized.

In this embodiment, the labor-saving lever structure 5 is provided with a casing 30, the elastic element 16 is provided in the casing 30, and the upper end of the elastic element 16 abuts against the inner wall of the casing 30 to be fixed.

For recombination, the straight pin 11 is still subjected to the elastic force of the elastic element 16 without loosening, that is, in the re-combining state, the elastic element 16 is set to a pre-compressed state, and when separated, the elastic element 16 will be further compressed. In this way, it is beneficial to improve reliability.

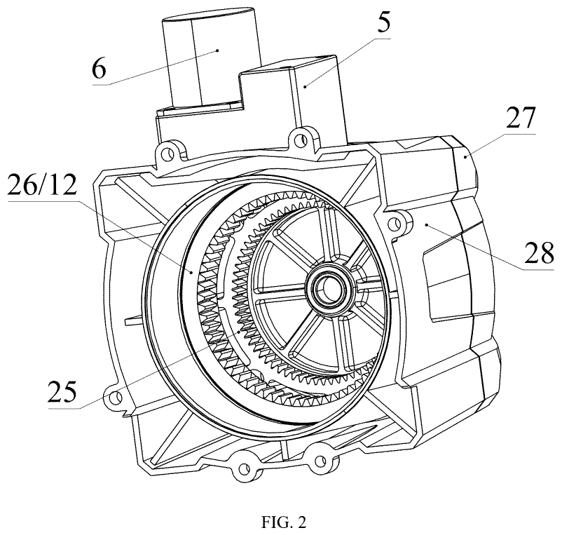

In some embodiments, as shown in FIGS. 2, 4 and 5, the planetary gear reducer 3 includes a first-stage inner gear ring 25 and a second-stage inner gear ring 26, the second-stage inner gear ring 26 being provided with radial limit holes 13. The second-stage inner gear ring 26 is provided near the side of the winch drum 2, and the straight pin 11 is provided on the circumference of the second-stage inner gear ring 26 and fits with the radial limit holes 13 of the second-stage inner gear ring 26. In this way, there is more room for setting the labor-saving lever structure 5 and the electric drive unit 6.

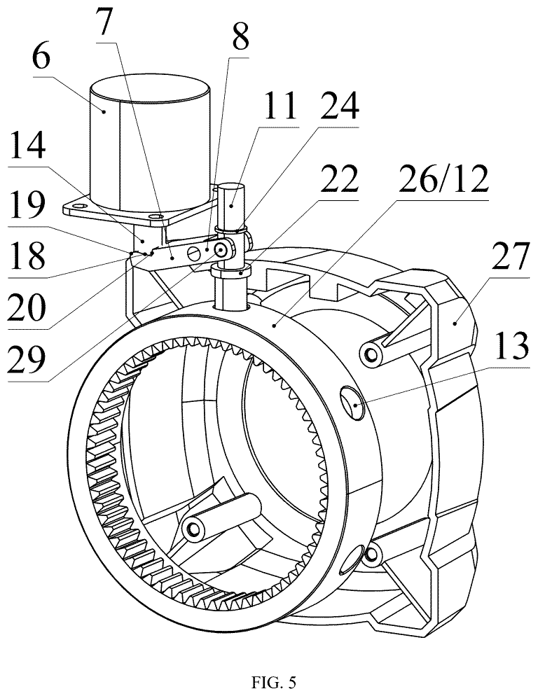

In some embodiments, as shown in FIGS. 4 and 5, the second-stage inner gear ring 26 is provided with a plurality of circumferentially arranged radial limit holes 13, so that the density of the radial limit holes 13 is increased, which is of great benefit to the case that the straight pin 11 is misaligned with the radial limit hole 13. That is, the front end of the straight pin 11 elastically abuts against the outer peripheral surface of the inner gear ring 12 under the action of elastic potential energy, and the inner gear ring 12 can be rotated by a small angle to realize the relative alignment of the straight pin 11 and the radial limit hole 13.

The planetary gear reducer 3 drives the winch drum 2 through multi-stage deceleration, thus realizing torque amplification and having greater load capacity. The first-stage inner gear ring 25 is used for the first-stage deceleration, and the second-stage inner gear ring 26 is used for the second-stage deceleration. For a better appearance, a decorative end cover 27 is attached to the rear end of the shell 28.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for case of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example. elements may be added to. removed from, or rearranged compared to the disclosed examples.

What is claimed is:

1. An electric winch with a radial electric clutch, comprising a bracket, a winch drum installed in the bracket, a planetary gear reducer connected to the bracket and an electric motor, wherein the electric motor is in transmission connection with the planetary gear reducer, and the planetary gear reducer is connected with the winch drum, wherein a labor-saving lever structure is provided on the circumference of the planetary gear reducer, and the labor-saving lever structure comprises a power arm and a resisting arm; a side of the power arm is connected with an electric drive unit, and a side of the resisting arm is hinged with a straight pin which moves radially; the straight pin is connected with a radial limit hole of an inner gear ring of the planetary gear reducer; and the electric drive unit is provided with a telescopic output end, and an abutting structure is provided between the side of the power arm and the output end; and the straight pin is connected with an elastic element which is used for driving the straight pin to be inserted into the radial limit hole; and
with the abutting structure, when separation is needed, the output end extend out and abuts against the side of the power arm to push the power arm, thereby driving the resisting arm to tilt, and the tilting of the resisting arm drives the straight pin to move radially to pull out the radial limit hole, thereby completing separation, while the elastic element is compressed or stretched by the straight pin to accumulate elastic potential energy; when recombination is needed, the output end retracts to release the limit to the power arm; under the action of the elastic potential energy, the straight pin moves reversely to push back the resisting arm, thus driving the power arm to reset; if the straight pin is aligned with the radial limit hole at this time, the straight pin is inserted into the radial limit hole to realize recombination; if the straight pin is not aligned with the radial limit hole at this time, the output end continues to retract, further away from the power arm to release the limit, while a front end of the straight pin elastically abuts against an outer peripheral surface of the inner gear ring under the action of the elastic potential energy; then when the inner gear ring rotates until the straight pin is relatively aligned with the radial limit hole, the straight pin will be inserted into the radial limit hole conveniently to realize recombination under the action of the elastic potential energy, and meanwhile, the release of the limit allows the power arm to realize the reset without obstacles.

2. The electric winch with a radial electric clutch according to claim 1, wherein a top of the planetary gear reducer is provided with the labor-saving lever structure, and the straight pin is vertically arranged in an up-and-down direction; the output end is provided by an output shaft of the electric drive unit, and the output shaft is also vertically arranged in the up-and-down direction.

3. The electric winch with a radial electric clutch according to claim 1, wherein an upper side of one end of the power arm far away from a support of the labor-saving lever structure is provided with a support plane; the output end is located on an upper side of the support plane, and the output end is vertically fitted with the support plane; and an end of the one end is provided with a guide cambered surface, which moves upward together with the power arm and is located below a lower side of the output end when being separated; the output end moves downward to first abut against the guide cambered surface when being recombined, and resumes the fitting with the support plane under the guidance of the guide cambered surface, thus completely recombining.

4. The electric winch with a radial electric clutch according to claim 3, wherein a vertical surface is provided on a side of the support plane close to the support, and the vertical surface and the support plane form an L-shaped structure.

5. The electric winch with a radial electric clutch according to claim 1, wherein a guide hole is provided in a shell of the planetary gear reducer, and the straight pin is in guide fit with the guide hole.

6. The electric winch with a radial electric clutch as claimed in claim 5, wherein the straight pin is provided with a first limit ring, which fits with the shell for a first limit on the straight pin, and the first limit is used for limiting the straight pin during recombination.

7. The electric winch with a radial electric clutch according to claim 5, wherein the straight pin is provided with a second limit ring, and the upper side of the straight pin on the second limit ring is provided with the elastic element, a lower end of which abuts against the second limit ring; an upper end of the elastic element is fixed, and the elastic element pushes the straight pin downward through the second limit ring.

8. The electric winch with a radial electric clutch as claimed in claim 7, wherein the straight pin is still subjected to the elastic force of the elastic element and does not loosen when being recombined.

9. The electric winch with a radial electric clutch according to claim 1, wherein the electric drive unit adopts an electromagnetic push rod, and a telescopic end of the electromagnetic push rod is used as the output end.

10. The electric winch with a radial electric clutch according to claim 1, wherein the planetary gear reducer comprises a second-stage inner gear ring, which is used as the inner gear ring; the second-stage inner gear ring is provided with a radial limit hole, and is provided near the side of the winch; the straight pin is arranged on the circumference of the second-stage inner gear ring and fits with the radial limit hole of the second-stage inner gear ring.

11. An electric winch with a radial electric clutch, comprising a bracket, wherein a rotatable winch drum, a planetary gear reducer drivingly connected with the winch drum and an electric motor for driving the planetary gear reducer are installed on the bracket in sequence; and
wherein, an electric clutch device operable to be disengaged is provided on the circumference of the planetary gear reducer, and the electric clutch device comprises a labor-saving lever structure and an electric drive unit; and
wherein, the labor-saving lever structure comprises a resisting arm and a power arm connected with the electric drive unit, and the resisting arm is hinged with straight pins; and
wherein the planetary gear reducer comprises at least one inner gear ring, which is provided with a plurality of radial limit holes fitted with the straight pins, and the straight pins are driven by the electric drive unit to be separated from the radial limit holes during clutching.

12. The electric winch with a radial electric clutch according to claim 11, wherein the electric drive unit is provided with a retractable output end, and an abutting structure is formed between the power arm and the output end; and the straight pin is provided with an elastic element for driving the straight pins to be inserted into the radial limit hole.

13. The electric winch with a radial electric clutch according to claim 12, wherein an upper side of the power arm is provided with a support plane abutting against the output end; and an end of one end of the support plane is provided with a guide cambered surface, and the electric drive unit comprises an output end abutting against the power arm; and
wherein, when the output end is re-engaged with the power arm, the output end is close to the power arm and preferentially abuts against the guide cambered surface, and the guide cambered surface guides the output end to be fitted with the support plane.

14. The electric winch with a radial electric clutch according to claim 13, wherein a side of the support plane close to the support is provided with a vertical surface, and the vertical surface and the support plane form an L-shaped structure.

15. The electric winch with a radial electric clutch according to claim 11, wherein the planetary gear reducer further comprises a shell, which is provided with guide holes that are in guiding fit with the straight pins.

16. The electric winch with a radial electric clutch according to claim 15, wherein an end of the straight pin is provided with a first limit ring, which fits with the shell to limit the straight pins.

17. The electric winch with a radial electric clutch according to claim 12, wherein the straight pin is provided with a second limit ring, and the elastic element is provided on an upper side of the second limit ring; a lower end of the elastic element abuts against the second limit ring, and an upper end of the elastic element is fixed; when the power arm is separated from the output end, the second limit ring pushes the straight pin downward to move by the elastic action of the elastic element.

18. The electric winch with a radial electric clutch according to claim 11, wherein the electric drive unit adopts an electromagnetic push rod, and the output end is a telescopic end of the electromagnetic push rod.

19. An electric winch with a radial electric clutch, comprising: a bracket, an electric motor installed on the bracket, a planetary gear reducer driven by the electric motor and a winch drum drivingly connected with the planetary gear reducer, wherein the planetary gear reducer comprises at least one inner gear ring, an electric drive unit and a labor-saving lever structure driven by the electric drive unit, and the inner gear ring is provided with a plurality of radial limit holes fitted with the labor-saving lever structure; and
wherein, the labor-saving lever structure is driven by the electric drive unit and enters or exits one of the plurality of radial limit holes in the inner gear ring.

20. The electric winch with a radial electric clutch according to claim 19, wherein the labor-saving lever structure comprises a power arm connected with the electric drive unit and a resisting arm hinged with straight pins; and
wherein, an abutting structure is formed between the electric drive unit and the power arm; an elastic element for driving the straight pins to be inserted into the radial limit hole is provided on the straight pin; when the straight pins enter the radial limit holes, the inner gear ring is drivingly coupled with the electric motor; when the straight pins exit the radial limit holes, the inner gear ring is drivingly decoupled from the electric motor.
